(19) United States
(12) Patent Application Publication
(10) Pub. No.: US 2016/0375532 A1
(43) Pub. Date: Dec. 29, 2016

(54) FASTENING DEVICE, ROBOT SYSTEM, AND FASTENING METHOD FOR FASTENING PLURALITY OF FASTENING MEMBERS

(71) Applicant: FANUC CORPORATION, Minamitsuru-gun (JP)

(72) Inventor: Masaaki Sasaki, Minamitsuru-gun (JP)

(73) Assignee: FANUC CORPORATION, Minamitsuru-gun (JP)

(21) Appl. No.: 15/263,542

(22) Filed: Sep. 13, 2016

Related U.S. Application Data
(62) Division of application No. 14/518,454, filed on Oct. 20, 2014.

(30) Foreign Application Priority Data
Oct. 24, 2013 (JP) 2013-221385

(51) Int. Cl. B23P 19/06; B25J 9/16; B23Q 3/16; B25J 15/00

(52) U.S. Cl. CPC B23P 19/069; B25J 15/0019; B25J 15/0052; B25J 9/1697; B23Q 3/16

(57) ABSTRACT

A fastening device enabling a plurality of fastening tools to be arranged at a plurality of fastening locations quickly. The fastening device includes a plurality of fastening tools, a movement mechanism for making the plurality of fastening tools move relative to each other, an imaging part imaging of a plurality of fastening locations, a fastening position calculating part calculating the positions of a plurality of fastening locations based on the image data, and a movement controller control the movement mechanism so as to make at least one fastening tool move so that the individual fastening tools are arranged at positions enabling the fastening members to be fastened to the corresponding fastening locations, based on the calculated plurality of fastening locations.

### CROSS REFERENCE TO RELATED APPLICATIONS

This application is a U.S. Divisional Application of U.S. patent application Ser. No. 14/518,454, filed Oct. 20, 2014, which claims priority to Japanese Patent Application No. 2013-221385, filed Oct. 24, 2013, the contents of such applications being incorporated by reference herein.

### BACKGROUND OF THE INVENTION

1. Field of the Invention

The present invention relates to a fastening device, a robot system, and a fastening method of fastening a plurality of fastening members to a workpiece.

2. Description of the Related Art

Known in the art is a robot which can fasten a plurality of fastening members, such as bolts, to an object, based on an image data of the imaged object such as a workpiece (for example, Japanese Patent Publication No. H05-293725A and Japanese Patent Publication No. 2003-225837A).

The robot described in the above patent publications includes a single fastening tool which can fasten a fastening member to an object. If performing fastening work, the robot positions the fastening tool at a fastening location formed at the object based on the image data of the imaged object. Therefore, according to such a robot, when it is necessary to fasten a plurality of fastening members to an object, it is necessary to separately position the single fastening tool at each of the plurality of fastening locations which are formed at the object, so a large amount of time ends up being spent for the fastening work.

Further, in the conventional art, there is also known a robot including a plurality of fastening tools, but in such a robot, the distance between the fastening tools (i.e., pitch) is fixed. Therefore, in such a s conventional robot, when it is necessary to fasten a plurality of fastening members to an object having various pitches, the fastening work cannot be performed efficiently, since it is not possible to change the pitches of the fastening tools in accordance with the pitches between the fastening locations formed at the object.

### SUMMARY OF THE INVENTION

In one aspect of the present invention, a fastening device for fastening a plurality of fastening members to a plurality of fastening locations provided at an object, includes a plurality of fastening tools; a movement mechanism for moving the plurality of fastening tools relative to each other, an imaging part which images the plurality of fastening locations; a fastening position calculating part which calculates the positions of the plurality of fastening locations based on an image data of the plurality of fastening locations imaged by the imaging part; and a movement controller which controls the movement mechanism based on the calculated positions of the plurality of fastening locations to move at least one of the fastening tools so that the individual fastening tools are arranged at positions where the individual fastening tools can fasten the fastening members to the corresponding fastening locations.

The plurality of fastening tools may have a fixed first fastening tool and a second fastening tool movable relative to the first fastening tool. In this case, the movement controller may control the movement mechanism to move the second fastening tool relative to the first fastening tool so that the distance between the first fastening tool and the second fastening tool becomes equal to the distance between a first fastening location and second fastening location of the plurality of fastening locations.

The fastening device may be further provided with a base to which the first fastening tool is fixed. The movement mechanism may include a rail which is provided at the base; a tool holding part which is movably attached to the rail and which holds the second fastening tool, and a power part which moves the tool holding part along the rail. The fastening device may be further provided with a plurality of tool drivers, each of which rotates each of the plurality of fastening tools; and a rotation controller which controls the plurality of tool drivers so as to simultaneously rotate the plurality of fastening tools.

In another aspect of the present invention, a robot system is provided with a robot arm; a robot controller which controls the robot arm; and the above fastening device. The robot controller includes a movement controller and controls the robot arm to position the plurality of fastening tools relative to the object.

The plurality of fastening tools may be attached to the robot arm. In this case, the robot arm may be operated so as to move the plurality of fastening tools to positions for performing fastening work on the object. Further, the plurality of fastening tools may be arranged at a location which is separated from the robot arm. In this case, the robot arm may grip the object and operate so as to move the object to a position where the plurality of fastening tools performs fastening work. Further, the robot controller may control the operation of the robot arm based on the image data.

In still another aspect of the present invention, a method for fastening a plurality of fastening members to a plurality of fastening locations provided at an object by a fastening machine which includes a plurality of fastening tools, includes steps of imaging the plurality of fastening locations, calculating positions of the plurality of fastening locations based on an image data of the imaged plurality of fastening locations; and moving at least one of the fastening tools based on the calculated positions of the plurality of fastening locations so that the individual fastening tools are arranged at positions where the individual fastening tools can fasten the fastening members to the corresponding fastening locations.

The plurality of fastening tools may include a first fastening tool and a second fastening tool which can move relative to the first fastening tool. In this case, the step of calculating the positions of the plurality of fastening locations may include calculating the distance between a first fastening location and a second fastening location of the plurality of fastening locations based on the image data.

Further, the step of moving the fastening tools may include moving the second fastening tool relative to the first fastening tool so that a distance between the first fastening tool and the second fastening tool becomes equal to the distance between the first fastening location and the second fastening location.

The method may further include positioning the plurality of fastening tools and the object relative to each other by a robot arm. The plurality of fastening tools may be attached to the robot arm. In this case, the step of positioning the plurality of fastening tools and the object relative to each other may include moving the plurality of fastening tools to positions for performing fastening work on the object by operation of the robot arm.

The plurality of fastening tools may be arranged at a location separated from the robot arm. In this case, the step of positioning the plurality of fastening tools and the object relative to each other may include gripping and transporting the object by the robot arm so as to move the object to a position where the plurality of fastening tools performs fastening work on the object.

### BRIEF DESCRIPTION OF THE DRAWINGS

FIG. 1 is a block diagram of a robot system according to one embodiment of the present invention;

FIG. 2 is an enlarged view of a fastening machine shown in FIG. 1;

FIG. 3A shows a top view of the object shown in FIG. 1;

FIG. 3B shows a cross-sectional view of the object cut along the line b-b in FIG. 3A;

FIG. 4 is a flow chart which shows a method of operation of the robot system shown in FIG. 1;

FIG. 5 is a flow chart which shows details of step S11 in FIG. 4;

FIG. 6A is a view for explaining step S1 in FIG. 4 and step S112 in FIG. 5 and shows the states before and after movement of the fastening tools at step S1;

FIG. 6B is a view of the fastening machine and the object shown in FIG. 6A as seen from the direction of arrow “b” shown in FIG. 6A;

FIG. 7 shows the arrangement of fastening tools and the object at the time of start of step S8 in FIG. 4;

FIG. 8 is a block diagram of a robot system according to another embodiment of the present invention;

FIG. 9 is a flow chart which shows a method of operation of the robot system shown in FIG. 8;

FIG. 10 is a flow chart which shows details of step S11′ in FIG. 9;

FIG. 11 is a view for explaining step S1′ in FIG. 9 and shows the states before and after movement of the fastening tools at step S1′; and

FIG. 12 is a view which shows the arrangement of the fastening tools and object at the time of start of step S8 in FIG. 9.

### DETAILED DESCRIPTION

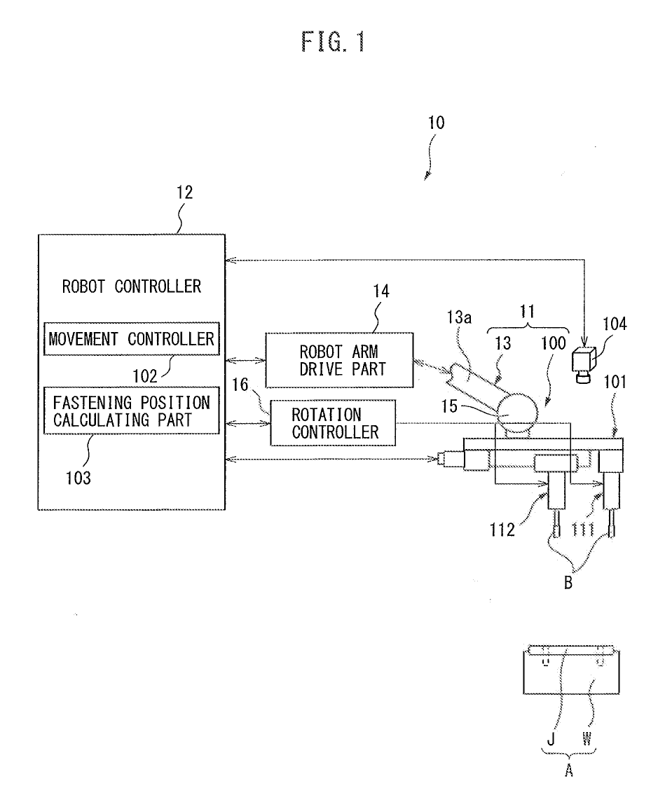

Below, embodiments of the present invention will be explained in detail based on the drawings. First, referring to FIG. 1, a robot system 10 according to an embodiment of the present invention will be explained. The robot system 10 according to the present embodiment is for fastening a plurality of bolts B as fastening members to an object A.

The robot system 10 includes a robot 11 for fastening bolts and a robot controller 12 which controls the robot 11. The robot controller 12 directly or indirectly controls each of elements constituting the robot 11. The robot 11, for example, is a vertical multi-articulated robot having a plurality of articulation axes, and includes a robot arm 13, a robot arm drive part 14 which drives the robot arm 13, and a fastening device 100.

The robot arm 13 is connected to a swivel stand (not shown) which can rotate about a vertical axis. The robot arm 13 includes a lower arm (not shown) attached to the swivel stand; and a front arm 13a attached to the lower arm. A wrist 15 is attached to the front end of the front arm 13a. The robot arm drive part 14 operates the robot arm 13 by driving servo motors provided at the articulation axes of the robot arm 13 in accordance with a command from the robot controller 12.

The fastening device 100 includes a fastening machine 101 which fastens the bolts B to the object A; a movement controller 102 for controlling movement of a later explained movement mechanism; a fastening position calculating part 103 which calculates positions of fastening locations on the object A where bolts B should be fastened; and an imaging part 104 for imaging the object A. In the present embodiment, the robot controller 12 executes the functions of the movement controller 102 and the fastening position calculating part 103. Details of the functions of the movement controller 102 and fastening position calculating part 103 will be explained later.

The imaging part 104 includes an image sensor, such as a CCD or CMOS sensor, and an image processor which processes the data of an imaged object. The imaging part 104 photoelectrically converts the object image entering through a lens and outputs an image data which is image-processed. The imaging part 104 images the object A in accordance with a command from the robot controller 12 and sends the image data of the object A to the robot controller 12. The imaging part 104, for example, is fixed to the robot arm 13, and positioned at a predetermined position when imaging the object A. The robot controller 12 pre-records the position of the imaging part 104 in the form of coordinates in a 3D space.

The robot system 10 includes a rotation controller 16 for rotating fastening tools 111, 112 provided at the fastening machine 101. The rotation controller 16 is communicably connected to the robot controller 12. The rotation controller 16 communicates with the robot controller 12 and rotates the fastening tools 111, 112 to fasten the bolts B to the object A.

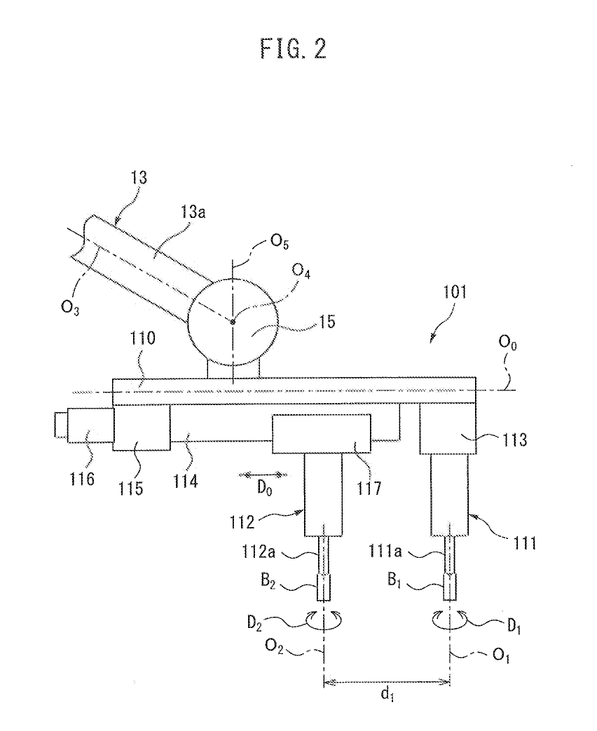

Next, referring to FIG. 2, the configuration of the fastening machine 101 will be explained in detail. The fastening machine 101 includes a base 110 connected to the wrist 15 of the robot arm 13; and a first fastening tool 111 and second fastening tool 112 which are provided at the base 110. The base 110 is a rod-shaped-member linearly extending along an axis O₀. At the bottom of the distal end of the base 110, a first tool holding part 113 downwardly projecting therefrom is fixed. The first fastening tool 111 is fixed to the base 110 via the first tool holding part 113.

Further, at the bottom of the base 110, a rail 114 linearly extending from the proximal end of the base 110 to a position in the vicinity of the first tool holding part 113 along the axis C₀ is fixed. The rail 114 is a hollow member and holds a screw shaft (not shown) inside thereof. A motor 116 is fixed to a proximal end part 115 of the base 110. The above-mentioned screw shaft is connected to an output shaft (not shown) of the motor 116. The motor 116 functions as a power part which drives, the output shaft to rotate in accordance with the command from the robot controller 12.

The second tool holding part 117 is movably attached to the rail 114. The second tool holding part 117 has a connecting part (not shown) which screws with the above-mentioned screw shaft. Via the connecting part, the second tool holding part 117 is driven along the axis O₀ as indicated by the arrows D₀ in the figure, as the screw shaft is driven to rotate by the motor 116. The second fastening tool 112 is held by the second tool holding part 117.

Therefore, the second fastening tool 112 moves along the axis O₀ together with the second tool holding part 117, as the second tool holding part 117 is moved. Thus, in the present embodiment, the second fastening tool 112 is moved along the axis O₀ by the rail 114; the second tool holding part 117 moving along the rail 114; the motor 116 which functions as the power part for driving the screw shaft; and a ball screw mechanism including the screw shaft. That is, the rail 114, second tool holding part 117, motor 116, and the ball screw mechanism function as a movement mechanism for moving the second fastening tool 112.

The first fastening tool 111 includes a shaft 111a extending along an axis O₁ perpendicular to the axis O₀; and a tool driver (not shown) which drives the shaft 111a to rotate. A first bolt B₁ to be fastened to the object A is set at the tip of the shaft 111a. The tool driver is arranged inside of the first fastening tool 111, and drives the shaft 111a to rotate about the axis O₁ as indicated by the arrows D₁ in the figure, in accordance with a command from the above-mentioned rotation controller 16.

Similarly, the second fastening tool 112 includes a shaft 112a extending along the axis O₂ parallel to the axis O₁; and a tool driver (not shown) which drives the shaft 112a to rotate. A second bolt B₂ to be fastened to the object A is set at the tip of the shaft 112a. The tool driver of the second fastening tool 112 is arranged inside of the second fastening tool 112, and drives the shaft 112a to rotate about the axis O₂ as indicated by the arrows D₂ in the figure, in accordance with a command from the above rotation controller 16.

The base 110 of the fastening machine 101 is connected to the front end of the front arm 13a of the robot arm 13 via the wrist 15. The wrist 15 holds the base 110 so as to be able to rotate about the axis O₄. The axis O₄ extends perpendicularly to the axis O₃ of the front arm 13a (extends in the front-back direction of FIG. 2). Further, the wrist 15 holds the base 110 so as to be able to rotate about the axis O₅. The axis O₅ is perpendicular to the axis O₄ and able to rotate about the axis O₄. The axis O₀ of the base 110 is perpendicular to the axis O₅ and able to rotate about the axis O₅.

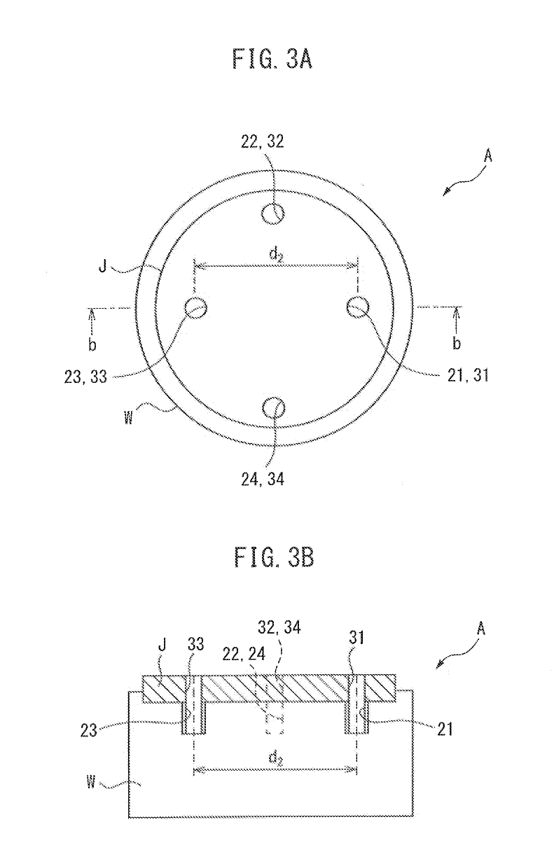

Next, referring to FIGS. 3A and 3B, the object A to which the bolts B are fastened by the fastening device 100 will be briefly explained. In the present embodiment, the object A includes a workpiece W and a jig J arranged on the workpiece W. The workpiece W is formed with a total of four screw holes 21, 22, 23, and 24 at predetermined positions.

Further, the jig J is formed with a total of four through holes 31, 32, 33, and 34 at positions corresponding to the screw holes 21, 22, 23, and 24 of the workpiece W. In order to fasten the workpiece W and the jig J together, the fastening device 100 inserts the bolts B through the through holes 31, 32, 33, and 34 of the jig J, and screws them into the screw holes 21, 22, 23, and 24 of the workpiece W, in the state where the jig J is arranged on the workpiece W as shown in FIGS. 3A and 3B.

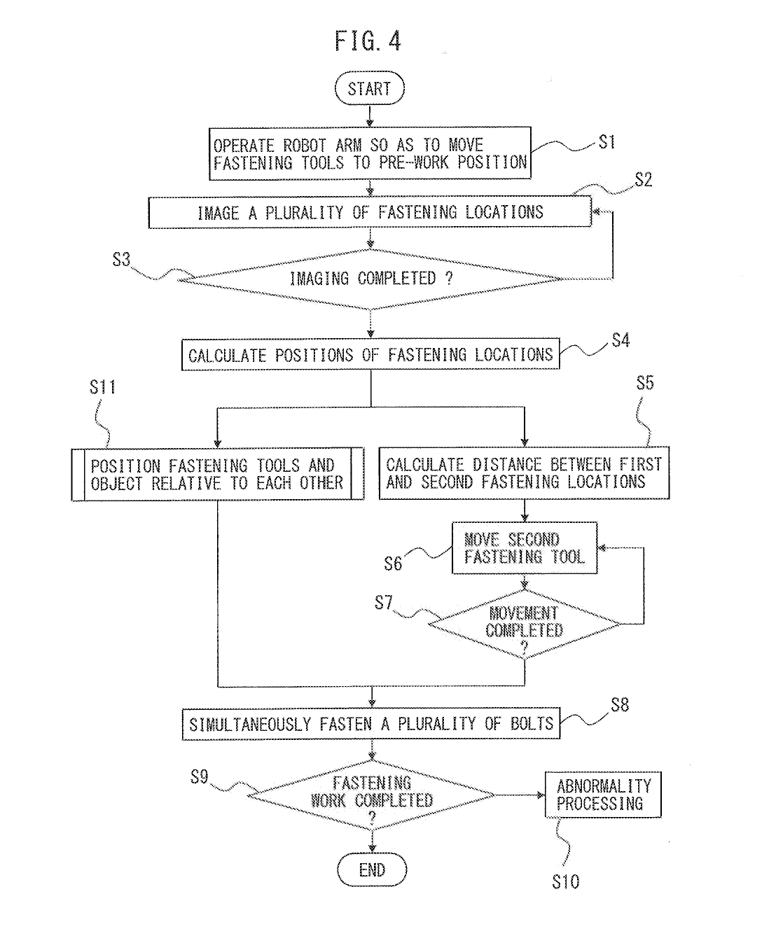

Next, referring to FIGS. 1-7, the operation of the robot system 10 according to the present embodiment will be explained. As explained above, the robot system 10 is for fastening the bolts B to the object A in order to fasten the workpiece W and the jig J together. As shown in FIG. 4, after the flow of operation according to the present embodiment is started, at step S1, the robot controller 12 operates the robot arm 13 so as to move the fastening tools 111, 112 to the pre-work position.

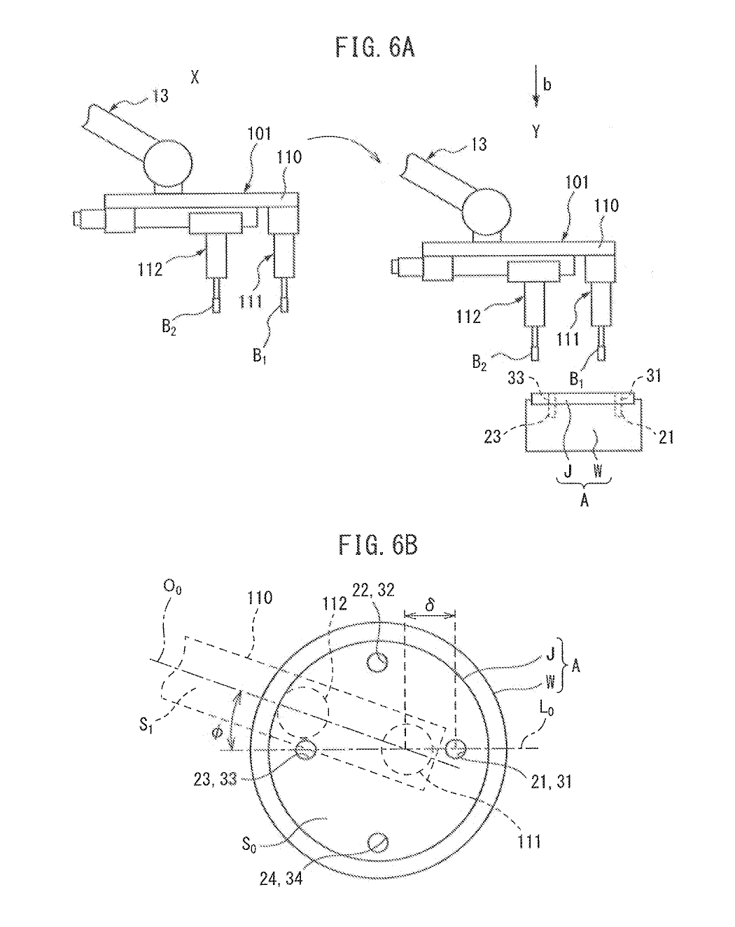

Specifically, the robot controller 12 sends a command to the robot arm drive part 14 in accordance with a robot program, and operates the robot arm 13 so as to arrange the fastening tools 111, 112 at the predetermined pre-work position near the object A. The operation at step S1 is shown schematically in FIG. 6A. As shown in FIG. 6A, at step S1, the fastening tools 111, 112 are moved by the operation of the robot arm 13 from the initial positions shown by “X” in the figure to the pre-work position shown by “Y” in the figure.

Note that, the above-mentioned robot program includes operating commands for the robot arm 13 in order to move the fastening tools 111, 112 to the pre-work position Y by the robot arm 13. This robot program is constructed by teaching the robot 11 the path from the position of the robot arm 13 at the initial position X to the position of the robot arm 13 at the pre-work position Y.

Referring again to FIG. 4, at step S2, the robot controller 12 images the plurality of fastening locations. Specifically, the robot controller 12 sends a command to the imaging part 104 so as to image the object A, which is transported by e.g. a conveyor to a predetermined position, from the top side of the object A. Due to this, the robot controller 12 images the through holes 31, 32, 33, and 34 formed at the jig J (or screw holes 21, 22, 23, and 24 formed at the workpiece W) as the plurality of fastening locations.

At step S3, the robot controller 12 determines whether the operation of imaging the fastening locations has been appropriately completed. Specifically, the robot controller 12 analyzes the image data received from the imaging part 104 and determines whether all of the total of the four through holes 31, 32, 33, and 34 have been recognized. When the robot controller 12 has recognized all of the through holes 31, 32, 33, and 34, it determines YES and proceeds to step S4. On the other hand, when the robot controller 12 was not able to recognize at least one of the through holes 31, 32, 33, and 34, it determines NO and returns to step S2.

At step S4, the robot controller 12 calculates the positions of the fastening locations in the object A where the bolts B should be fastened. Specifically, the robot controller 12 calculates the coordinates of the through holes 31, 32, 33, and 34 provided at the jig J (i.e., screw holes 21, 22, 23, and 24 of workpiece W) based on the image data of the object A; the coordinates of the imaging part 104; and visual line data of the imaging part 104. Thus, in the present embodiment, the robot controller 12 functions as the fastening position calculating part 103 which calculates the positions of the fastening locations based on the image data.

After step S4, at step S5, the robot controller 12 calculates the distance between two fastening locations. Specifically, the robot controller 12 calculates the distance between two of the through holes 31, 32, 33, and 34, for example, the distance d₂ between the through holes 31 and 33 of the jig J as shown in FIGS. 3A and 3B, with using the coordinates of the through holes 31, 32, 33, and 34 calculated at step S4.

At step S6, the robot controller 12 moves the second fastening tool 112 relative to the first fastening tool 111 based on the calculated distance between two fastening locations. Specifically, the robot controller 12 drives the motor 116 to rotate, and moves the second fastening tool 112 so that the distance d₁ (FIG. 2) between the first fastening tool 111 and the second fastening tool 112 becomes equal to the distance d₂ calculated at step S5. Thus, in the present embodiment, the robot controller 12 functions as the movement controller 102 which controls the movement mechanism so as to arrange the individual fastening tools at the corresponding fastening locations.

At step S7, the robot controller 12 determines whether movement of the second fastening tool 112 has been completed. For example, the robot controller 12 determines whether the second fastening tool 112 has been moved so that the distances d₁ and d₂ become equal based on the number of rotation of the motor 116.

The robot controller 12 proceeds to step S8 when determining YES. When determined YES at step S7 in this way, the first fastening tool 111 and second fastening tool 112 are arranged at positions where the bolts B₁ and B₂ can be fastened at the corresponding screw holes 21 and 23 respectively. On the other hand, when determined NO, the robot controller 12 returns to step S6.

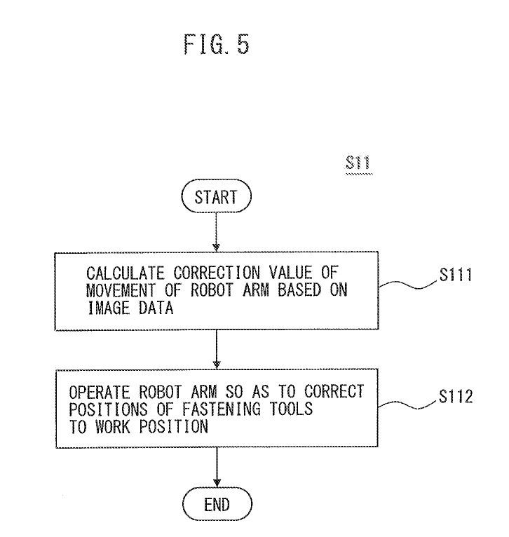

On the other hand, after step S4, the robot controller 12 executes step S11 in parallel with steps S5-S7. At step S11 the robot controller 12 positions the fastening tools 111, 112 and the object A relative to each other. This step S11 will be explained with reference to FIG. 5.

After step S11 is started, at step S111, the robot controller 12 calculates the correction value of movement of the robot arm 13 based on the image data obtained at step S2. Specifically, the robot controller 12 calculates the correction value of movement of the robot arm 13 for moving the fastening tools 111, 112 to work positions where the fastening work on the object A can be performed, in reference to the coordinates of the through holes 31, 32, 33, and 34 calculated from the image data.

This step S111 will be explained more specifically, in reference to FIG. 6B. FIG. 6B is a view showing the fastening machine 101 and object A arranged at the pre-work position as seen from the arrow “b” in FIG. 6A. Note that, in FIG. 6B, from the viewpoint of ease of understanding, the base 110 of the fastening machine 101 and the fastening tools 111 and 112 are shown by dashed-lines.

At step S111, as the above correction value, the robot controller 12 calculates e.g. a distance difference δ between the first fastening tool 111 and a screw hole 21 formed at the workpiece W (through hole 31 of jig J); a first angular difference φ between a virtual line L₀, which connects the screw hole 21 (through hole 31 of jig J) and screw hole 23 (through hole 33 of jig J), and the axis O₀ of the base 110; and a second angular difference between a top surface S₀ of the jig J and a plane S₁ (i.e., a top surface of the base 110) perpendicular to the axes O₁ and O₂ of the fastening tools 111 and 112.

Referring to FIG. 5 again, at step S112, the robot controller 12 corrects the positions of the fastening tools 111, 112 to the work position where they can perform fastening work on the object A, based on the correction value of movement calculated at step S111. Specifically, the robot controller 12 operates the robot arm 13 via the robot arm drive part 14 so as to correct the positions of the fastening tools 111, 112 so that the distance difference δ, the first angular difference φ, and the second angular difference become zero.

As a result, the top surface S₀ of the jig J and the plane S₁ perpendicular to the axes O₁ and O₂ of the fastening tools 111 and 112 become parallel with each other. Further, the first fastening tool 111 is positioned at the center axis of the screw hole 21 (through hole 31 of jig J), and the axis O₀ of the base 110 and the virtual line L₀ match each other. After completing step S112, the robot controller 12 ends step S11 and proceeds to step S8 shown in FIG. 4.

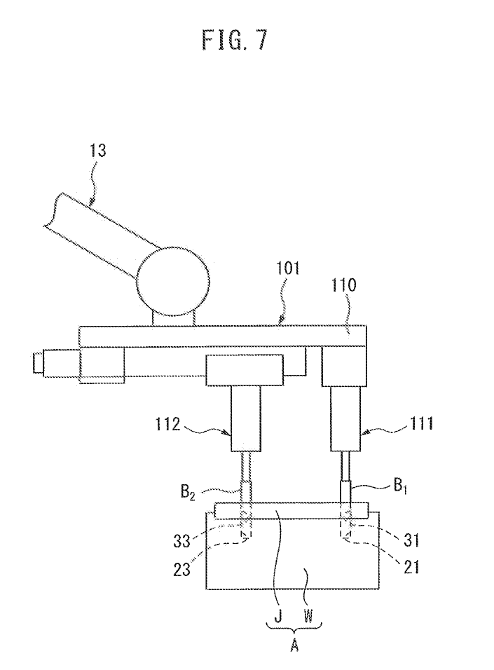

As explained above, in the present embodiment, steps S5-S6 for moving the second fastening tool 112 with respect to the first fastening tool 111 and step S11 for positioning the fastening tools 111, 112 at the work position are performed in parallel. Therefore, at the time of start of step S8, the first fastening tool 111 and second fastening tool 112 are positioned at the screw hole 21 (through hole 31) and screw hole 23 (through hole 33), as shown in FIG. 7.

At step S8, the robot controller 12 simultaneously fastens a plurality of bolts B₁ and B₂ by the fastening tools 111 and 112. Specifically, the robot controller 12 communicates with the rotation controller 16, and the rotation controller 16 simultaneously drives the shaft 111a of the first fastening tool 111 and shaft 112a of the second fastening tool 112 to rotate. As a result, the bolts B₁ and B₂ are simultaneously fastened in the screw holes 21 and 23 of the workpiece W.

At step S9, the robot controller 12 determines whether the fastening work has been appropriately performed. For example, the rotation controller 16 sends a fastening abnormality signal to the robot controller 12 when the fastening torque upon fastening the bolts B₁ and B₂ does not reach a predetermined value within a certain time. The robot controller 12 determines NO when receiving a fastening abnormality signal, and then proceeds to step S10. On the other hand, the robot controller 12 determines YES when not receiving a fastening abnormality signal within a certain period, and ends the flow shown in FIG. 4.

At step S10, the robot controller 12 starts the abnormality processing step. In the abnormality processing step, the robot controller 12 determines the object A which was not appropriately fastened as a defective product, and operates the robot arm 13 so as to transport the object A to a location where the defective product should be stored. Then, the robot controller 12 ends the flow shown in FIG. 4.

Otherwise, the robot controller 12 may again perform the fastening work at the abnormality processing step. In this case, the robot controller 12 communicates with the rotation controller 16, and the rotation controller 16 turns the fastening tool, for which the fastening abnormality was detected, in a direction opposite to the direction in step S8, so as to loosen the bolt B. After this, the rotation controller 16 again performs the fastening work by turning the bolt B in the same direction as step S8. Then, the robot controller 12 returns to step S9.

According to the present embodiment, the robot controller 12 moves the fastening tools 111, 112 to the work position for performing fastening work with using the image data imaged by the imaging part 104, and moves the second fastening tool so as to arrange the fastening tools 111, 112 at the corresponding fastening locations. Due to this, it is possible to quickly arrange a plurality of fastening tools 111, 112 at a plurality of fastening locations with a high precision. Therefore, it is possible to improve the manufacturing efficiency of the products, since the time necessary for fastening the bolts B could be shortened.

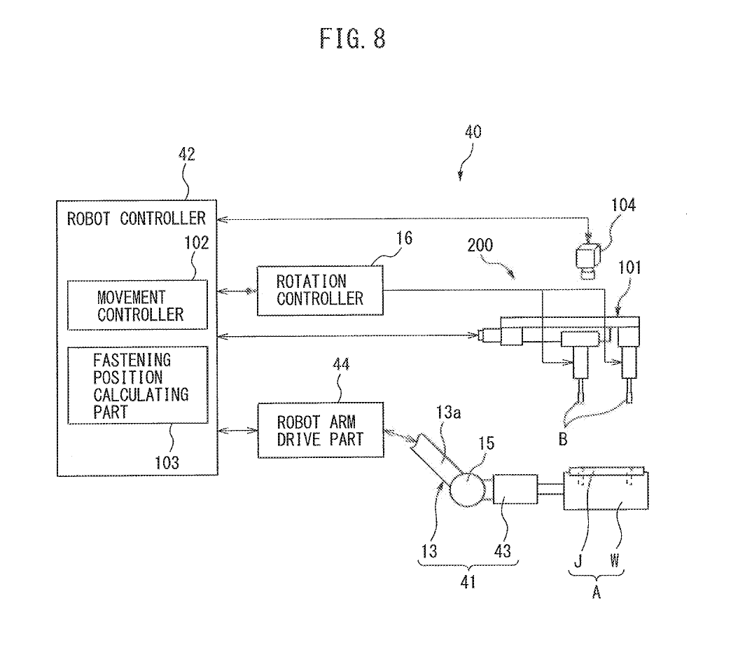

Next, referring to FIG. 8, a robot system 40 according to another embodiment of the present invention will be explained. Note that the element similar to the above-mentioned embodiment is assigned the same numeral reference, and detailed explanation therefor will be omitted. The robot system 40 includes a robot 41; a robot controller 42 which controls the robot 41; and a fastening device 200 which is fixed to a predetermined position. In the same way as the above embodiments, the robot controller 42 executes the functions of the movement controller 102 and fastening position calculating part 103.

The robot 41 includes a robot arm 13; a robot arm drive part 44 which drives the robot arm 13; and a robot hand 43. The robot hand 43 is attached to the front end of the front arm 13a of the robot arm 13 via the wrist 15. The robot hand 43 grips and lifts the object A, and releases the gripped object A.

The robot arm drive part 44 drives the servo motors provided at the articulation axes of the robot arm 13 so as to operate the robot arm 13, in accordance with a command from the robot controller 42. Further, the robot arm drive part 44 operates the robot hand 43 to grip and release the object A in accordance with a command from the robot controller 42.

Similar to the above embodiment, the fastening device 200 includes a fastening machine 101; movement controller 102; fastening position calculating part 103; and imaging part 104. The fastening machine 101 has a configuration similar to the embodiment shown in FIG. 2, and is fastened to a predetermined position separated from the robot arm 13. For example, the base 110 of the fastening machine 101 is fastened to the wall provided at a robot cell in the manufacturing line. Further, the robot system 40 includes a rotation controller 16 for rotating the fastening tools 111, 112.

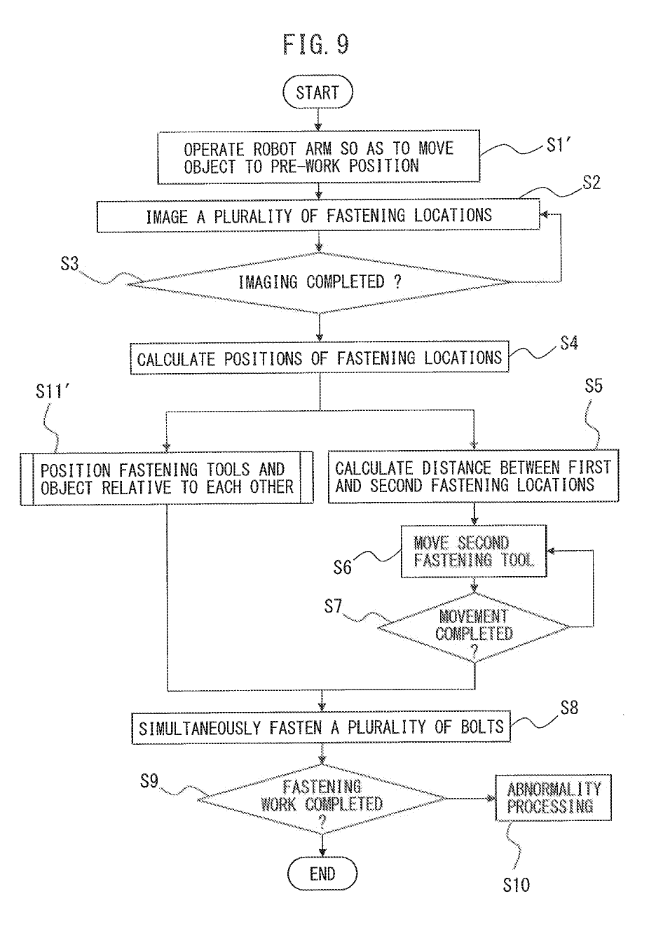

Next, referring to FIGS. 8-12, the operation of the robot system 40 according to the present embodiment will be explained. In the flow according to the present embodiment, the robot controller 42 performs step S2 to step S10 shown in FIG. 4 in the same way as the above embodiments other than step S1′ and step S11′ shown in FIG. 9. Therefore, a detailed explanation of step S2 to step S10 will be omitted and step S1′ and step S11′ will be explained below.

After the flow shown in FIG. 9 is started, at step S1′, the robot controller 42 operates the robot arm 13 to move the object A to a pre-work position. Specifically, the robot controller 42 sends a command to the robot arm drive part 44 in accordance with the robot program and operates the robot arm 13 so as to arrange the object A gripped by the robot hand 43 at the predetermined pre-work position in the vicinity of the fastening tools 111, 112.

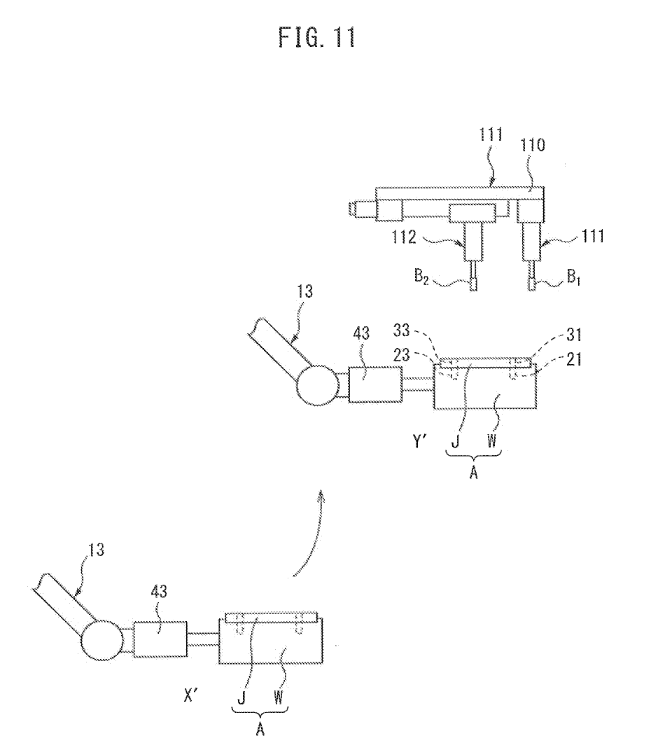

The operation of step S1′ will be schematically shown in FIG. 11. As shown in FIG. 11, at step S1′, the object A gripped by the robot hand 43 is moved by operation of the robot arm 13 from the initial position indicated by X′ in the figure to the pre-work position indicated by Y′ in the figure.

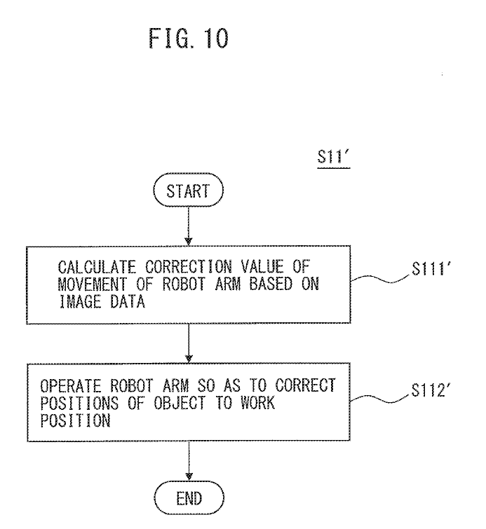

Referring again to FIG. 9, after step S4, the robot controller 42 executes step S11′ in parallel with steps S5-S7. At step S11′, the robot controller 42 positions the fastening tools 111, 112 and the object A relative to each other. This step S11′ will be explained with reference to FIG. 10.

After the start of step S11′, at step S111′, the robot controller 42 calculates a correction value of movement of the robot arm 13 based on the image data obtained at step S2. Specifically, the robot controller 42 calculates the correction value of movement of the robot arm 13 for moving the object A to a work position where the fastening work on the object A can be performed by means of the fastening tools 111, 112, based on the coordinates of the through holes 31, 32, 33, and 34 calculated from the image data.

For example, as the above correction value of movement, the robot controller 42 calculates the distance difference δ (FIG. 6B) between the first fastening tool 111 and the screw hole 21 formed at the workpiece W (through hole 31 of jig J); the first angular difference φ (FIG. 6B) between the virtual line L₀, which connects the screw hole 21 (through hole 31 of jig J) and screw hole 23 (through hole 33 of jig J), and the axis O₀ of the base 110; and the second angular difference between the top surface S₀ of the jig J and the plane S₁ (i.e., the top surface of the base 110) perpendicular to the axes O₁ and O₂ of the fastening tools 111 and 112, in the same way as the above-mentioned step S111.

At step S112′ the robot controller 42 corrects the position of the object A to the work position based on the correction value of movement calculated at step S111′. For example, the robot controller 42 operates the robot arm 13 via the robot arm drive part 44 so as to correct the position of the object A so that the distance difference δ, first angle difference φ, and second angle difference become zero.

As a result, the top surface S₀ of the jig J and the plane S₁ perpendicular to the axes O₁, O₂ of the fastening tools 111, 112 become parallel, the first fastening tool 111 is positioned at the center axis of the screw hole 21 (through hole 31 of jig J), and the axis O₀ of the base 110 and the virtual line L₀ coincide each other. After step S112′ ends, the robot controller 42 ends step S11′ and proceeds to step S8 shown in FIG. 9.

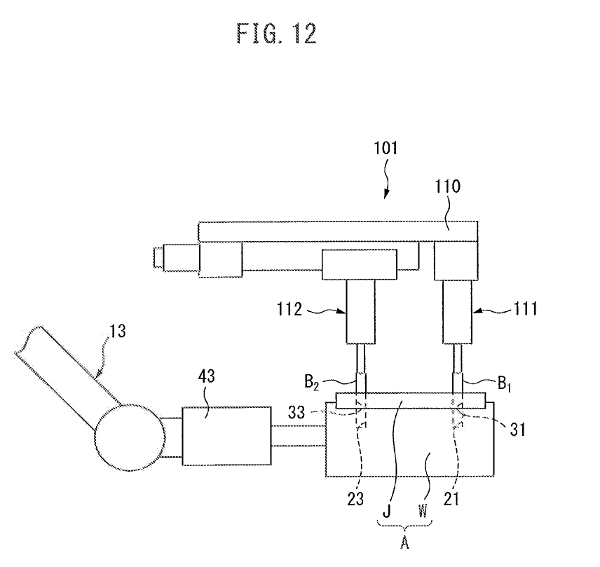

In this way, in the present embodiment, steps S5-S7 for moving the second fastening tool 112 with respect to the first fastening tool 111 and step S11′ for arranging the object A at the work position are executed in parallel. Therefore, at the time of start of step S8, the first fastening tool 111 and second fastening tool 112 are positioned at the screw hole 21 (through hole 31) and screw hole 23 (through hole 33), as shown in FIG. 12.

According to the present invention, it is possible to quickly arrange a plurality of fastening tools 111, 112 at a plurality of fastening locations with a high precision. Accordingly, it is possible to improve the manufacturing efficiency of the products, since the time necessary for fastening the bolts B could be shortened.

Note that, in the above embodiments, the case wherein the fastening device 100 is incorporated in the robot systems 10, 40 was explained. However, the invention is not limited to this. Even the fastening device 100 alone can fasten a plurality of fastening members. Below, the configuration and operation of the fastening device 100 in the case where the fastening device 100 alone performs the fastening work will be explained.

In this case, the fastening device 100 includes a fastening device controller as an element corresponding to the above-mentioned robot controller 12; and the above-mentioned rotation controller 16. The fastening device controller directly or indirectly controls the elements which constitute the fastening device 100. The fastening device controller functions as the above-mentioned movement controller 102 and fastening position calculating part 103, and controls the imaging operation of the imaging part 104. Further, the fastening device controller communicates with the rotation controller 16 so as to rotate the shaft 111a of the first fastening tool 111 and the shaft 112a of the second fastening tool 112.

When performing the fastening work, the fastening device controller performs steps S2-S8 shown in FIG. 4. An example of the flow of operation of the fastening device will be explained simply below. After the flow of operation of the fastening device starts, at step S2, the fastening device controller sends a command to the imaging part 104 and images a plurality of fastening locations. At step S3, the fastening device controller determines whether the imaging operation of the fastening locations has been appropriately completed. At step S4, the fastening device controller functions as a fastening position calculating part 103, and calculates the positions of the fastening locations where the bolts B should be fastened to the object A based on the image data.

At step S5, the fastening device controller calculates the distance between two fastening locations. At step S6, the fastening device controller functions as the movement controller 102 and move the second fastening tool 112 relative to the first fastening tool 111 based on the calculated distance d₂ between two fastening locations. At step S7, the fastening device controller determines whether the movement of the second fastening tool 112 has been completed. Then, at step S8, the fastening device controller communicates with the rotation controller 16 so as to simultaneously fasten the plurality of bolts B by means of the fastening tools.

According to such a fastening device 100 as well, it is possible to move one of the fastening tools so as to arrange the individual fastening tools at the corresponding fastening locations, with using the image data imaged by the imaging part 104. Due to this, it is possible to quickly arrange a plurality of fastening tools to a plurality of fastening locations with a high precision. Therefore, it is possible to improve the manufacturing efficiency of the products, since the time necessary for fastening work could be shortened.

Note that, in the above embodiments, the case where the fastening device is provided with two fastening tools was explained, but the invention is not limited to this. The fastening device may also be provided with three or more fastening tools. Further, in the above embodiment, the case where the second fastening tool moved along one direction was explained, but the invention is not limited to this. The second fastening tool may also, for example, be configured to move on an x-y plane in any direction. Such a configuration can be realized by a ball screw mechanism which includes an x-axial direction screw shaft which is arranged along the x-axis and a y-axial direction screw shaft which is arranged along the y-axial direction.

Further, in the above embodiments, the case where the robot controller calculates as the correction values of movement the distance difference δ, first angle difference φ, and second angle difference was explained. However, the invention is not limited to this. The robot controller, for example, may calculate the correction values of movement from the difference between the coordinates of the plurality of fastening tools and the coordinates of the fastening locations on the object or may use any other parameters as the basis for calculating the correction values of movement.

In the above embodiments, the case of teaching a robot the path from the position of the robot arm at the initial positions X to the position of the robot arm at the pre-work position Y so as to make the fastening tools move to the pre-work position Y will be explained. However, the invention is not limited to this. The robot controller 12 records coordinates which correspond to the pre-work position Y in advance and refers to the coordinates to make the robot arm operate and arrange the fastening tools at the pre-work position Y.

In the above way, according to the present invention, it is possible to use image data which was imaged by the imaging part to make a plurality of fastening tools move to positions for performing fastening work and possible to make one of the fastening tools move so as to arrange the individual fastening tools at the corresponding fastening locations. Due to this, it is possible to arrange a plurality of fastening tools with respect to a plurality of fastening locations quickly and with a high precision. For this reason, it is possible to shorten the time which is required for fastening work, so it is possible to improve the manufacturing efficiency of the products.

Above, the present invention was explained through embodiments of the present invention, but the above embodiments do not limit the invention relating to the claims. Further, all combinations of features which were explained in the embodiment are not necessarily essential for the invention. Further, the above embodiments can be changed or improved in various ways as clear to a person skilled in the art. Such changed or improved embodiments are also included in the technical scope of the present invention as clear from the claim language.

Further, it should be noted that the operations, routines, steps, stages, and other processing in the apparatus, system, program, and method in the claims, specification, and drawings, unless particularly clearly indicated by “before”, “in advance of”, etc. or the output of prior processing being used for later processing, can be realized in any order. In the flow of operations in the claims, specification, and drawings, even if explained using “first”, “next”, etc. for convenience, this does not mean the execution in this order is essential.

1. A robot system comprising:
a robot arm;
a robot controller controlling the robot arm; and
a fastening device including:
a first fastening tool which is fixed;
a second fastening tool movable relative to the first fastening tool;
a movement mechanism for moving the second fastening tool relative to the first fastening tool, the movement mechanism including:
a ball screw mechanism having a screw shaft which engages the second fastening tool; and
a motor which generates power to rotate the screw shaft in order to move the second fastening tool relative to the first fastening tool;
an imaging part imaging a plurality of fastening locations;
a fastening position calculating part calculating the positions of the plurality of fastening locations based on an image data of the plurality of fastening locations imaged by the imaging part, the fastening position calculating part calculating a distance between a first fastening location and a second fastening location of the calculated positions of the plurality of fastening locations; and
a movement controller which rotates the motor so as to move the second fastening tool relative to the first fastening tool so that a distance between the first fastening tool and the second fastening tool becomes equal to the distance between the first fastening location and the second fastening location,
wherein the robot controller has a function of the movement controller and controls the robot arm so as to position the plurality of fastening tools relative to the object,
wherein the plurality of fastening tools is arranged at a location separated from the robot arm, and
wherein the robot arm moves the object by gripping and operating the object to a position where the plurality of fastening tools performs fastening work.

2. A method for fastening a plurality of fastening members to a plurality of fastening locations provided at an object by a fastening device including:
a first fastening tool which is fixed;
a second fastening tool movable relative to the first fastening tool; and
a movement mechanism for moving the second fastening tool relative to the first fastening tool, the movement mechanism including:
a ball screw mechanism having a screw shaft which engages the second fastening tool; and
a motor which generates power to rotate the screw shaft in order to move the second fastening tool relative to the first fastening tool,
the method comprising:
imaging the plurality of fastening locations;
calculating positions of the plurality of fastening locations based on an image data of the imaged plurality of fastening locations, and calculating a distance between a first fastening location and a second fastening location of the plurality of fastening locations by using the calculated positions of the plurality of fastening locations;
moving the second fastening tool relative to the first fastening tool by rotating the motor so that a distance between the first fastening tool and the second fastening tool becomes equal to the distance between the first fastening location and the second fastening location; and
positioning the plurality of fastening tools and the object relative to each other by a robot arm,
wherein the plurality of fastening tools is arranged at a location separated from the robot arm, and
wherein the step of positioning the plurality of fastening tools and the object relative to each other includes gripping and transporting the object by the robot arm so as to move the object to a position where the plurality of fastening tools performs fastening work.
